(19) United States
(12) Patent Application Publication
(10) Pub. No.: US 2007/0027285 A1
(43) Pub. Date: Feb. 1, 2007

(54) Polyurethanes

(76) Inventors: Pathiraja A. Gunatillake, Mulgrave (AU); Ajay Padsalgikar, Wheelers Hill (AU); Raju Adhikari, Wheelers Hill (AU); Ian Griffiths, Elwood (AU); Mark Bown, Notting Hill (AU)

Correspondence Address: SCHWEGMAN, LUNDBERG, WOESSNER & KLUTH, P.A., P.O. BOX 2938, MINNEAPOLIS, MN, 55402, US

(21) Appl. No.: 11/440,575

(22) Filed: May 25, 2006

Related U.S. Application Data
(63) Continuation of application No. PCT/AU04/01662, filed on Nov. 26, 2004.

(30) Foreign Application Priority Data
Nov. 28, 2003 (AU) 2003906639

(51) Int. Cl. C08L 83/10; C08G 77/60

(52) U.S. Cl. 528/28; 528/29; 528/38; 525/464

(57) ABSTRACT

The present invention relates to cross linked polyurethanes or polyurethane ureas and processes for their preparation. The polyurethanes are biostable and creep resistant which makes them useful in the manufacture of biomaterials and medical devices, articles or implants, in particular orthopaedic implants such as spinal disc prostheses.

### RELATED APPLICATIONS

This application is a continuation under 35 U.S.C. 111(a) of International Application No. PCT/AU2004/001662 filed Nov. 26, 2004 and published in English as WO 2005/052019 A1 on Jun. 9, 2005, which claims priority from Australian Application No. 2003906639 filed Nov. 28, 2003, which applications are incorporated herein by reference.

### FIELD OF THE INVENTION

The present invention relates to cross linked polyurethanes or polyurethane ureas and processes for their preparation. The polyurethanes are biostable and creep resistant which makes them useful in the manufacture of biomaterials and medical devices, articles or implants, in particular orthopaedic implants such as spinal disc prostheses.

### BACKGROUND OF THE INVENTION

The development of methodology^{1,2} to incorporate high proportions of siloxane segments as part of the polyurethane structure has resulted in the production of a range of thermoplastic siloxanepolyurethanes (Elast-Eon™) with biostability and mechanical properties suitable for a variety of medical implants. These thermoplastic polyurethanes are used in a range of cardiovascular, interventional cardiology and cardiac rhythm management applications. Materials that are used in medical implants subjected to cyclic strains or compressions such as orthopaedic implants require excellent flex-fatigue and creep resistance. Thermoplastic polymers generally exhibit a significant level of permanent deformation (creep) under tensile and compression loads. As a consequence, thermoplastic polyurethanes have limited use in load-bearing applications such as orthopaedic implants where dimensional stability is critical for optimum performance of the implant. There is a need for biostable polyurethanes which possess creep resistance.

### SUMMARY OF THE INVENTION

According to the present invention there is provided a cross linked polyurethane or polyurethane urea having an NCO/OH or NH₂ stoichiometry of 1-1.015 which comprises a soft segment which is formed from:

at least one polyether macrodiol and/or at least one polycarbonate macrodiol; and

(a) at least one polysiloxane macrodiol, at least one polysiloxane macrodiamine and/or at least one silicon-based polycarbonate; and/or

a hard segment which is formed from:

(b) a polyisocyanate; and

(c) at least one di-functional chain extender,

wherein the soft segment and/or the hard segment are further formed from:

(d) at least one cross linking agent.

Further according to the present invention there is provided a compound of formula (V): 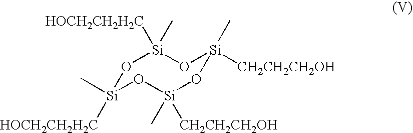
which is a suitable silicon-containing cross linking agent for use in forming the polyurethanes of the present invention.

The present invention also provides a process for preparing the polyurethanes defined above which comprises the steps of:
(i) reacting components (a), (b) and (c) as defined above to form a prepolymer having terminally reactive polyisocyanate groups; and
(ii) reacting the prepolymer with components (d) and (e) defined above.

The present invention further provides a process for preparing the polyurethanes defined above which comprises the steps of:
(i) mixing components (a), (b), (d) and (e) defined above; and
(ii) reacting the mixture with component (c).

The polyurethanes of the present invention are biostable and creep resistant. These properties make the polyurethanes useful in the manufacture of biomaterials and medical devices, articles or implants.

Thus, the present invention also provides a material, device, article or implant which is wholly or partly composed of the polyurethanes defined above.

### BRIEF DESCRIPTION OF THE DRAWINGS

In the Examples, reference will be made to the accompanying drawings in which:

FIG. 1 is a graph showing the tensile creep resistance of the polyurethanes of Example 1.

FIG. 2 is a graph showing the creep loading (˜1 MPa) and recovery in compression of the polyurethanes of Examples 2 to 6;

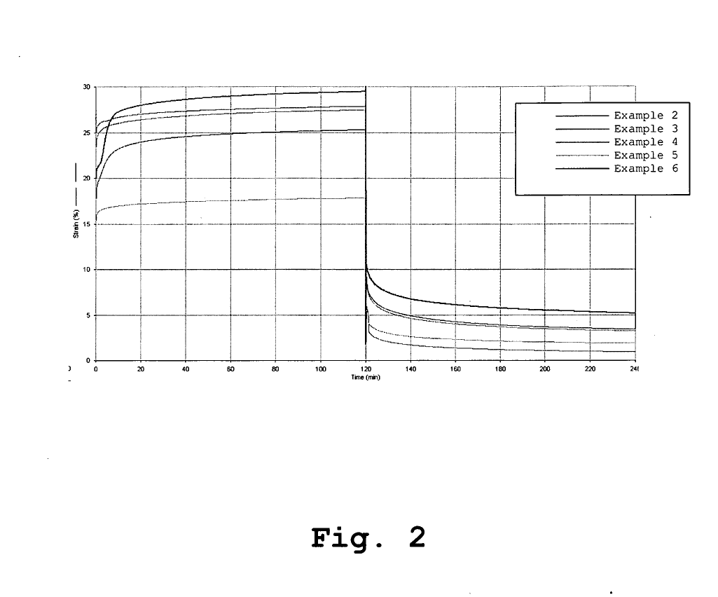

FIG. 3 is a graph showing the creep loading (˜5 MPa) and recovery in tension for the polyurethanes of Examples 2 to 7;

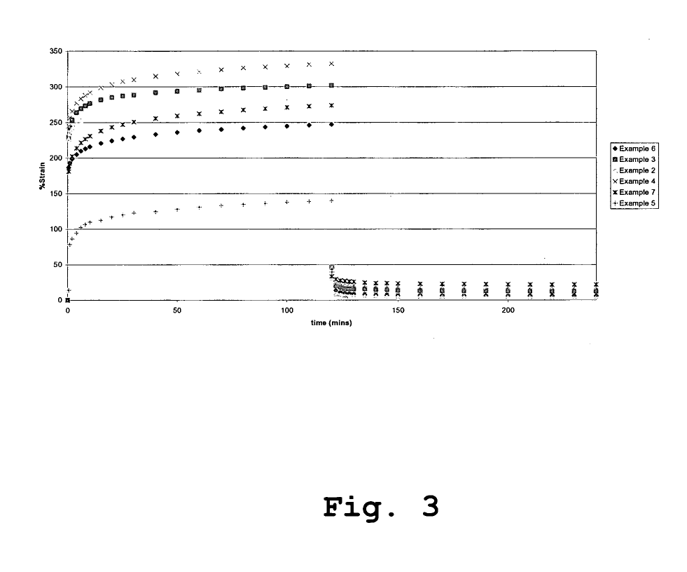

FIG. 4 is a graph showing the creep loading (˜5 MPa) and recovery in tension for the polyurethanes of Example 8; and

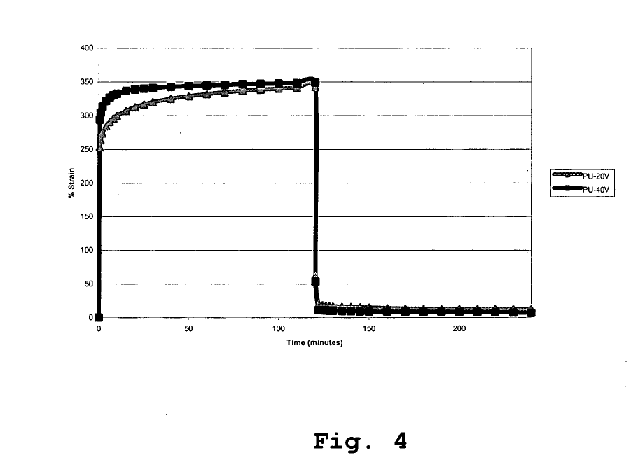

FIG. 5 is a graph showing the creep loading (˜1 MPa) and recovery in compression of the polyurethanes of Example 8.

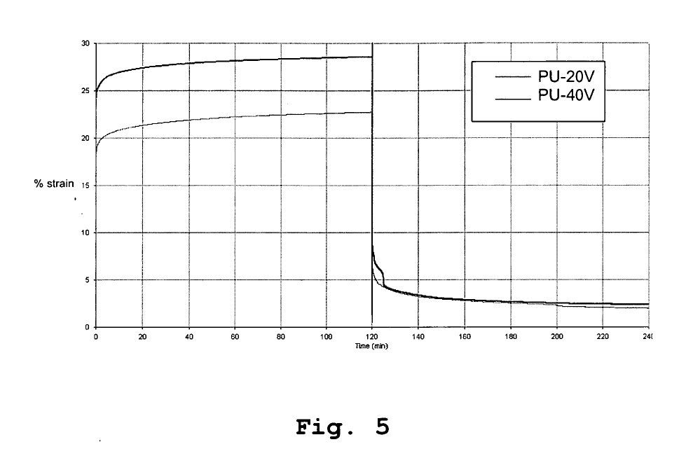

### DETAILED DESCRIPTION OF THE INVENTION

In the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

The cross linking agent (e) which forms part of the soft and/or hard segment preferably has 3 or more functional groups. The functional group may be any type of group which can react with isocyanate and is preferably selected from OH or NR′R″ in which R′ and R″ are the same or different and selected from H, CO₂H and C₁₋₆ alkyl, preferably H and C₁₋₄ alkyl.

Examples of tri, tetra, hexa and octa-hydroxyl functional cross linking agents include trimethylol propane (TMP), trifunctional polyether polyol based on propoxylated glycerines such as Voranol 2770, pentaerythritol (PE), pentaerythritol tetrakis(2-mercapto acetate), dipentaerythritol (DPE) and tripentaerythritol (TPE).

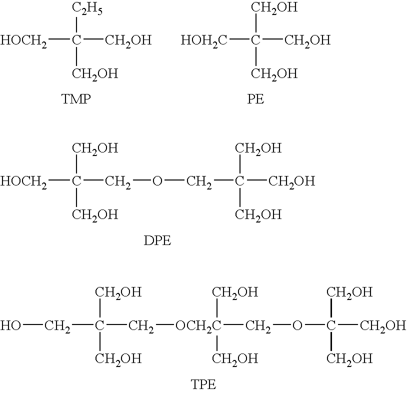

An example of an amine cross linker is triethanol amine.

When cross linking agents such as TMP are incorporated into the hard segment of the polyurethane, the expected general structure is shown in Scheme I below:

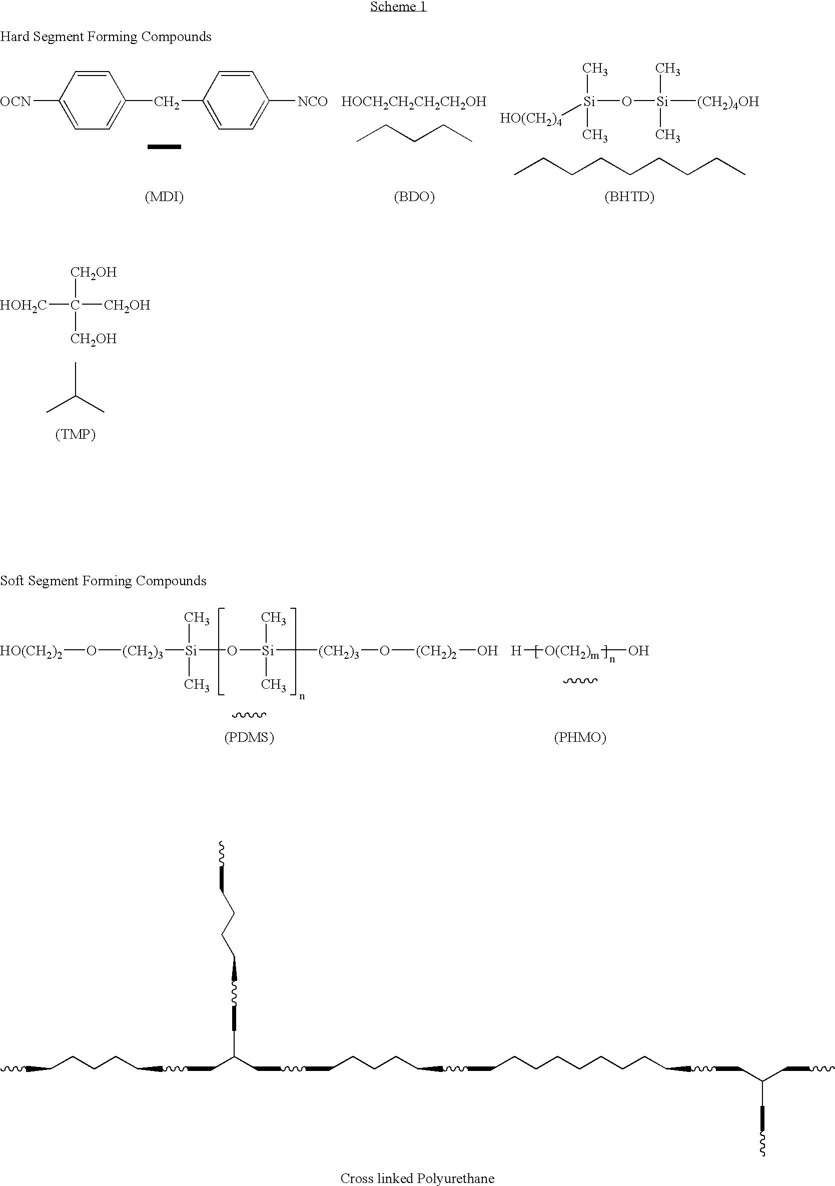

The introduction of cross linking may cause some changes to polyurethane morphology. The effect may be minor if the desired improvement in creep resistance can be achieved by relatively lower level of cross linking, minimising the disruption to the hard segment ordering.

It will be appreciated that silicon-containing cross linking agents may also be used in the polyurethanes of the present invention. Examples include cyclic siloxanes of the formula (VII): 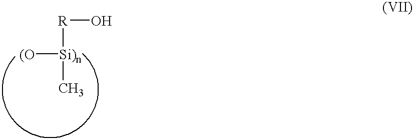
wherein
n is an integer of 3 or greater; and
R is an optionally substituted straight chain, branched or cyclic, saturated or unsaturated hydrocarbon radical having a backbone of at least 3 carbon atoms.

An example of a cyclic siloxane is tetramethyl tetrahydroxy propyl cyclotetrasiloxane of formula (V) shown above. Another suitable silicon-containing cross linking agent is 1,3(6,7-dihydroxy ethoxypropyl)tetramethyl disiloxane of formula (VI):

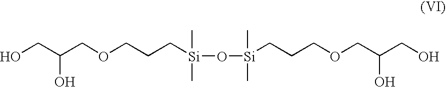

The soft and hard segments of the polyurethanes typically phase separate and form separate domains. The hard segments organise to from ordered (crystalline) domains while the soft segments remain largely as amorphous domains and the two in combination is responsible for the excellent mechanical properties of polyurethanes. The introduction of cross links will affect this phase separation and the ordering of the hard and/or soft domains.

The soft segment which is formed from components (a) and (b) is preferably a combination of at least two macrodiols, at least two macrodiamines or at least one macrodiol and at least one macrodiamine.

Suitable polyether macrodiols include those represented by the formula (I)
HO—[(CH₂)ₘ—O]ₙ—H (I)
wherein

m is an integer of 4 or more, preferably 5 to 18; and

n is an integer of 2 to 50.

Polyether macrodiols of formula (I) wherein m is 5 or higher such as polyhexamethylene oxide (PHMO), polyheptamethylene oxide, polyoctamethylene oxide (POMO) and polydecamethylene oxide (PDMO) are preferred over the conventional polytetramethylene oxide (PTMO). The more preferred macrodiols and their preparation are described in Gunatillake et al³ and U.S. Pat. No. 5,403,912. Polyethers such as PHMO described in these references are particularly useful as they are more hydrophobic than PTMO and more compatible with polysiloxane macrodiols. The preferred molecular weight range of the polyether macrodiol is about 200 to about 5000, more preferably about 200 to about 1200. It will be understood that the molecular weight values referred to herein are “number average molecular weights”.

Suitable polycarbonate macrodiols include poly(alkylene carbonates) such as poly(hexamethylene carbonate) and poly(decamethylene carbonate); polycarbonates prepared by reacting alkylene carbonate with alkanediol for example 1,4-butanediol, 1,10-decanediol (DD), 1,6-hexanediol (HD) and/or 2,2-diethyl 1,3-propanediol (DEPD); and silicon based polycarbonates prepared by reacting alkylene carbonate with 1,3-bis(4-hydroxybutyl)-1,1,3,3-tetramethyldisiloxane (BHTD) and/or alkanediols.

It will be appreciated when both the polyether and polycarbonate macrodiols are present, they may be in the form of a mixture or a copolymer. An example of a suitable copolymer is a copoly(ether carbonate) macrodiol represented by the formula (II) 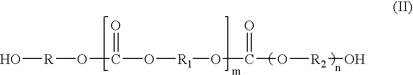
wherein

R₁ and R₂ are the same or different and selected from an optionally substituted straight chain, branched or cyclic alkylene, alkenylene, alkynylene or heterocyclic radical; and

m and n are integers of 1 to 20.

Although the compound of formula (II) above indicates blocks of carbonate and ether groups, it will be understood that they also could be distributed randomly in the main structure.

The polysiloxane macrodiol or macrodiamine may be represented by the formula (III): 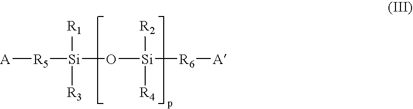
wherein

A and A′ are OH or NHR wherein R is H or an optionally substituted straight chain, branched or cyclic, saturated or unsaturated hydrocarbon radical, preferably C₁₋₆ alkyl, more preferably C₁₋₄ alkyl;

R₁, R₂, R₃ and R₄ are the same or different and selected from hydrogen or an optionally substituted straight chain, branched or cyclic, saturated or unsaturated hydrocarbon radical;

R₅ and R₆ are the same or different and selected from an optionally substituted straight chain, branched or cyclic alkylene, alkenylene, alkynylene or heterocyclic radical; and

p is an integer of 1 or greater.

Preferred polysiloxanes are polysiloxane macrodiols which are polymers of the formula (III) wherein A and A′ are hydroxy and include those represented by the formula (IIIa): 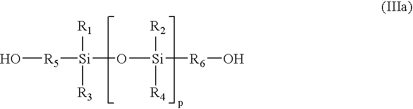
wherein

R₁ to R₆ and p are as defined in formula (III) above.

A preferred polysiloxane is PDMS which is a compound of formula (IIIa) wherein R₁ to R₄ are methyl and R₅ and R₆ are as defined above. Preferably R₅ and R₆ are the same or different and selected from propylene, butylene, pentylene, hexylene, ethoxypropyl (—CH₂CH₂OCH₂CH₂CH₂—), propoxypropyl and butoxypropyl.

The polysiloxane macrodiols may be obtained as commercially available products such as X-22-160AS from Shin Etsu in Japan or prepared according to known procedures. The preferred molecular weight range of the polysiloxane macrodiol is about 200 to about 6000, more preferably about 500 to about 2500.

Other preferred polysiloxanes are polysiloxane macrodiamines which are polymers of the formula (III) wherein A is NH₂, such as, for example, amino-terminated PDMS.

Suitable silicon-based polycarbonates include those described in International Patent Publication No. WO 98/54242, the entire content of which is incorporated herein by reference.

A preferred silicon-based polycarbonate has the formula (IV): 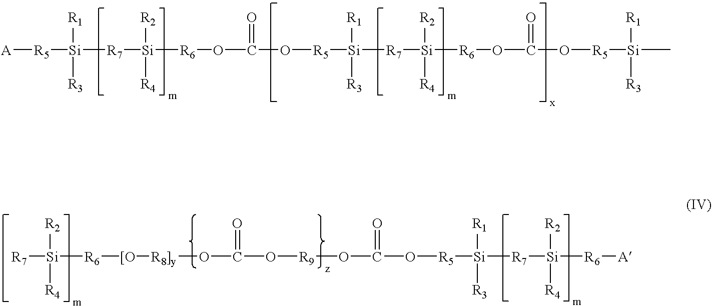
wherein

R₁, R₂, R₃, R₄ and R₅ are as defined in formula (III) above;

R₆ is an optionally substituted straight chain, branched or cyclic alkylene, alkenylene, alkynylene or heterocyclic radical;

R₇ is a divalent linking group, preferably O, S or NR₈;

R₈ and R₉ are same or different and selected from hydrogen or an optionally substituted straight chain, branched or cyclic, saturated or unsaturated hydrocarbon radical;

A and A′ are as defined in formula (III) above;

m, y and z are integers of 0 or more; and

x is an integer of 0 or more.

Preferably z is an integer of 0 to about 50 and x is an integer of 1 to about 50. Suitable values for m include 0 to about 20, more preferably 0 to about 10. Preferred values for y are 0 to about 10, more preferably 0 to about 2.

A preferred polycarbonate is a compound of the formula (IV) wherein A and A′ are hydroxy which is a polycarbonate macrodiol of the formula (IVa): 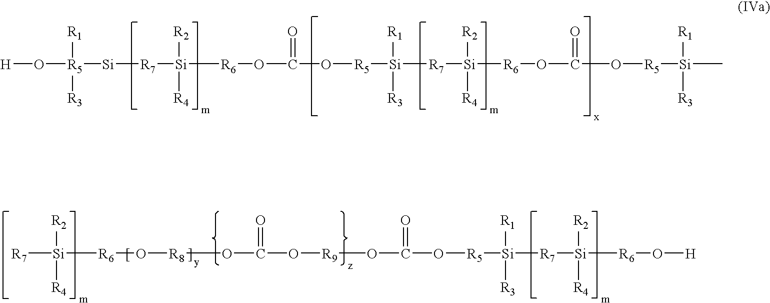
wherein

R₁ to R₉, m, y, x and z are as defined in formula (IV) above.

Particularly preferred polycarbonate macrodiols are compounds of the formula (IVa) wherein R₁, R₂, R₃ and R₄ are methyl, R₈ is ethyl, R₉ is hexyl, R₅ and R₆ are propyl or R₄ butyl and R₇ is 0 or —CH₂—CH₂—, more preferably R₅ and R₆ are propyl when R₇ is 0 and R₅ and R₆ are butyl when R₇ is —CH₂—CH₂—. The preferred molecular weight range of the polycarbonate macrodiol is about 400 to about 5000, more preferably about 400 to about 2000.

In a particularly preferred embodiment, the soft segment is a combination of PDMS or amino-terminated PDMS with a polyether of the formula (I) such as PHMO and/or a silicon-based polycarbonate such as siloxy carbonate.

The term “polyisocyanate” is used herein in its broadest sense and refers to di or higher isocyanates such as polymeric 4,4′-diphenylmethane diisocyanate (MDI). The polyisocyanate is preferably a diisocyanate which may be aliphatic or aromatic diisocyanates such as, for example MDI, methylene biscyclohexyl diisocyanate (H₁₂MDI), p-phenylene diisocyanate (p-PDI), trans-cyclohexane-1,4-diisocyanate (CHDI), 1,6-diisocyanatohexane (DICH), 1,5-diisocyanatonaphthalene (NDI), para-tetramethylxylenediisocyanate (p-TMXDI), meta-tetramethylxylene diisocyanate (m-TMXDI), 2,4-toluene diisocyanate (2,4-TDI) isomers or mixtures thereof or isophorone diisocyanate (IPDI). MDI is particularly preferred.

The term “di-functional chain extender” in the present context means any compound having two functional groups per molecule, which are capable of reacting with the isocyanate group and generally have a molecular weight range of about 500 or less, preferably about 15 to about 500, more preferably about 60 to about 450.

The di-functional chain extender may be selected from diol or diamine chain extenders. Examples of diol chain extenders include 1,4-butanediol, 1,6-hexanediol, 1,8-octanediol, 1,9-nonanediol, 1,10-decanediol, 1,12-dodecanediol,1,4-cyclohexanediol, 1,4-cyclohexanedimethanol, p-xyleneglycol, 1,3-bis(4-hydroxybutyl)tetramethyldisiloxane, 1,3-bis(6-hydroxyethoxypropyl)tetramethyldisiloxane and 1,4-bis(2-hydroxyethoxy)benzene. Suitable diamine chain extenders include 1,2-ethylenediamine, 1,3-propanediamine,1,4-butanediamine, 1,3-bis(3-aminopropyl)tetramethyldisiloxane, 1,3-bis(4-aminobutyl)tetramethyldisiloxane and 1,6-hexanediamine.

The chain extender may also be a silicon-containing chain extender of the type described in International Patent Publication No. WO 99/03863, the entire contents of which are incorporated herein by reference. Such chain extenders include a silicon-containing diol of the formula (VI): 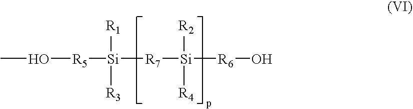
wherein

R₁, R₂, R₃, R₄, R₅ and R₆ are as defined in formula (III) above;

R₇ is as defined in formula (IV) above, more preferably O; and

q is 0 or greater, preferably 2 or less.

Preferred silicon-containing diols of the formula (VI) are 1,3-bis(4-hydroxybutyl)tetramethyl disiloxane (BHTD) (compound of formula (VI) wherein R₁, R₂, R₃ and R₄ are methyl, R₅ and R₆ are butyl and R₇ is O), 1,4-bis(3-hydroxypropyl)tetramethyl disilylethylene (compound of formula (VI) wherein R₁, R₂, R₃ and R₄ are methyl, R₅, and R₆, are propyl and R₇ is ethylene) and 1-4-bis(3-hydroxypropyl)tetramethyl disiloxane, more preferably BHTD.

The silicon-containing chain extender of formula (VI) may be combined with the diol or diamine chain extenders described above. In a particularly preferred embodiment the chain extender of formula (VI) is BHTD and the diol chain extender is BDO.

The silicon chain extender and diol or diamine chain extender can be used in a range of molar proportions with decreasing tensile properties as the molar percentage of the silicon chain extender increases in the mixture. A preferred molar percentage of silicon chain extender relative to the diol or diamine chain extender is about 1 to about 70%, more preferably about 60%. For example, when the chain extender is a combination of BHTD and BDO, then the relative proportions of these components is preferably 40% BHTD and 60% BDO.

Although the preferred chain extender contains one diol or diamine chain extender and one silicon-containing diol, it will be understood that combinations of more than one diol or diamine chain extender may be used in the polyurethanes of the present invention.

The “hydrocarbon radical” may include alkyl, alkenyl, alkynyl, aryl or heterocyclyl radicals.

The term “alkyl” denotes straight chain, branched or mono- or poly-cyclic alkyl, preferably C₁₋₁₂ alkyl or cycloalkyl, more preferably C₁₋₆ alkyl, most preferably C₁₋₄ alkyl. Examples of straight chain and branched alkyl include methyl, ethyl, propyl, isopropyl, butyl, isobutyl, sec-butyl, tert-butyl, amyl, isoamyl, sec-amyl, 1,2-dimethylpropyl, 1,1-dimethylpropyl, pentyl, neopentyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1,2-pentylheptyl and the like. Examples of cyclic alkyl include cyclopropyl, cyclobutyl, cyclopentyl, cyclohexyl, cycloheptyl, cyclooctyl, cyclononyl, cyclodecyl and the like.

The term “alkenyl” denotes groups formed from straight chain, branched or mono- or poly-cyclic hydrocarbon groups having at least one double bond, preferably C₂₋₁₂ alkenyl, more preferably C₂₋₆ alkenyl. The alkenyl group may have E or Z stereochemistry where applicable. Examples of alkenyl include vinyl, allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1-heptenyl, 3-heptenyl, 1-octenyl, cyclooctenyl, 1-nonenyl, 2-nonenyl, 3-nonenyl, 1-decenyl, 3-decenyl, 1,3-butadienyl, 1,4-pentadienyl, 1,3-cyclopentadienyl, 1,3-hexadienyl, 1,4-hexadienyl, 1,3-cyclohexadienyl, 1,4-cyclohexadienyl, 1,3-cycloheptadienyl, 1,3,5-cycloheptatrienyl, 1,3,5,7-(cycloocta-tetraenyl) and the like.

The term “alkynyl” denotes groups formed from straight chain, branched, or mono- or poly-cyclic hydrocarbon groups having at least one triple bond. Examples of alkynyl include ethynyl, 1-propynyl, 1- and 2-butynyl, 2-methyl-2-propynyl, 2-pentynyl, 3-pentynyl, 4-pentynyl, 2-hexynyl, 3-hexynyl, 4-hexynyl, 5-hexynyl, 10-undecynyl, 4-ethyl-1-octyn-3-yl, 7-dodecynyl, 9-dodecynyl, 10-dodecynyl, 3-methyl-1-dodecyn-3-yl, 2-tridecynyl, 11-tridecynyl, 3-tetradecynyl, 7-hexadecynyl, 3-octadecynyl and the like.

The term “aryl” denotes single, polynuclear, conjugated and fused residues of aromatic hydrocarbons. Examples of aryl include phenyl, biphenyl, terphenyl, quaterphenyl, phenoxyphenyl, naphthyl, tetrahydronaphthyl, anthracenyl, dihydroanthracenyl, benzanthracenyl, dibenzanthracenyl, phenanthrenyl and the like.

The term “heterocyclyl” denotes mono- or poly-cyclic heterocyclyl groups containing at least one heteroatom selected from nitrogen, sulphur and oxygen. Suitable heterocyclyl groups include N-containing heterocyclic groups, such as, unsaturated 3 to 6 membered heteromonocyclic groups containing 1 to 4 nitrogen atoms, for example, pyrrolyl, pyrrolinyl, imidazolyl, pyrazolyl, pyridyl, pyrimidinyl, pyrazinyl, pyridazinyl, triazolyl or tetrazolyl; saturated 3 to 6 membered heteromonocyclic groups containing 1 to 4 nitrogen atoms, such as pyrrolidinyl, imidazolidinyl, piperidino or piperazinyl; unsaturated condensed heterocyclic groups containing 1 to 5 nitrogen atoms, such as, indolyl, isoindolyl, indolizinyl, benzimidazolyl, quinolyl, isoquinolyl, indazolyl, benzotriazolyl or tetrazolopyridazinyl; unsaturated 3 to 6-membered heteromonocyclic group containing an oxygen atom, such as, pyranyl or furyl; unsaturated 3 to 6-membered heteromonocyclic group containing 1 to 2 sulphur atoms, such as, thienyl; unsaturated 3 to 6-membered heteromonocyclic group containing 1 to 2 oxygen atoms and 1 to 3 nitrogen atoms, such as, oxazolyl, isoazolyl or oxadiazolyl; saturated 3 to 6-membered heteromonocyclic group containing 1 to 2 oxygen atoms and 1 to 3 nitrogen atoms, such as, morpholinyl; unsaturated condensed heterocyclic group containing 1 to 2 oxygen atoms and 1 to 3 nitrogen atoms, such as, benzoxazolyl or benzoxadiazolyl; unsaturated 3 to 6-membered heteromonocyclic group containing 1 to 2 sulphur atoms and 1 to 3 nitrogen atoms, such as thiazolyl or thiadiazolyl; saturated 3 to 6-membered heteromonocyclic group containing 1 to 2 sulphur atoms and 1 to 3 nitrogen atoms, such as, thiadiazolyl; and unsaturated condensed heterocyclic group containing 1 to 2 sulphur atoms and 1 to 3 nitrogen atoms, such as benzothiazolyl or benzothiadiazolyl.

In this specification, “optionally substituted” means that a group may or may not be further substituted with one or more groups selected from oxygen, nitrogen, sulphur, alkyl, alkenyl, alkynyl, aryl, halo, haloalkyl, haloalkenyl, haloalkynyl, haloaryl, hydroxy, alkoxy, alkenyloxy, alkynyloxy, aryloxy, carboxy, benzyloxy, haloalkoxy, haloalkenyloxy, haloalkynyloxy, haloaryloxy, nitro, nitroalkyl, nitroalkenyl, nitroalkynyl, nitroaryl, nitroheterocyclyl, azido, amino, alkylamino, alkenylamino, alkynylamino, arylamino, benzylamino, acyl, alkenylacyl, alkynylacyl, arylacyl, acylamino, acyloxy, aldehydo, alkylsulphonyl, arylsulphonyl, alkylsulphonylamino, arylsulphonylamino, alkylsulphonyloxy, arylsulphonyloxy, heterocyclyl, heterocycloxy, heterocyclylamino, haloheterocyclyl, alkylsulphenyl, arylsulphenyl, carboalkoxy, carboaryloxy, mercapto, alkylthio, arylthio, acylthio and the like.

Preferably, the amount of hard segment in the polyurethanes of the present invention is about 15 to about 100 wt %, more preferably about 20 to about 70 wt %, most preferably about 30 to about 60 wt %. However, it will be appreciated that this amount is dependent on the type of soft segment polymer used, in particular the molecular weight range of the soft segment which is generally about 300 to about 3000, more preferably about 300 to about 2500, most preferably about 500 to about 2000.

The soft segment preferably includes macrodiols derived from 40 to 98 wt %, more preferably 40 to 90%, of polysiloxane and 2 to 60 wt %, more preferably 10 to 60 wt % of a polyether and/or polycarbonate macrodiol.

The weight ratio of polysiloxane and/or silicon-based polycarbonate to polyether and/or polycarbonate in the preferred soft segment may be in the range of from 1:99 to 99:1. A particularly preferred ratio of polysiloxane to polyether and/or polycarbonate which provides increased degradation resistance, stability and clarity is 80:20. Another preferred ratio of polysiloxane and/or silicon-based polycarbonate to polyether and/or polycarbonate when the chain extender includes a silicon-containing chain extender such as BHTD is 40:60.

The polyurethanes of the present invention may be prepared by any technique familiar to those skilled in the manufacture of polyurethanes. These include one or two-step bulk or solution polymerisation procedures. The polymerisation can be carried out in conventional apparatus or within the confines of a reactive injection moulding or mixing machines.

In a one-step bulk polymerisation procedure the appropriate amount of components (a), (b) and (e) are mixed with the chain extender (d) first at temperatures in the range of about 45 to about 100° C., more preferably about 60 to about 80° C. If desired a catalyst such as stanneous octoate or dibutyltin dilaurate at a level of about 0.001 to about 0.5 wt % based on the weight of the total ingredients may be added to the initial mixture. Molten polyisocyanate (c) is then added and mixed thoroughly to give a homogeneous polymer liquid and cured by pouring the liquid polymer into Teflon—coated trays and heating in an oven to about 100° C.

The polyurethanes are preferably prepared by a two-step method where a prepolymer having terminally reactive polyisocyanate groups is prepared by reacting components (a) and (b) as defined above with a polyisocyanate component (c). The prepolymer is then reacted with the chain extender (d) and the cross linking agent (e).

The processes described above here do not generally cause premature phase separation and yield polyurethanes that are compositionally homogeneous and transparent having high molecular weights. These processes also have the advantage of not requiring the us of any solvent to ensure that the soft and hard segments are compatible during synthesis.

A further advantage of the incorporation of polysiloxane segments is the relative ease of processing of the polyurethane by conventional methods such as reactive injection moulding, rotational moulding, compression moulding and foaming without the need of added processing waxes. If desired, however, conventional polyurethane processing additives such as catalysts for example dibutyl tin dilaurate (DBTD), stannous oxide (SO), 1,8-diazabicyclo[5,4,0]undec-7-ene (DABU), 1,3-diacetoxy-1,1,3,3-tetrabutyldistannoxane (DTDS), 1,4-diaza-(2,2,2)-bicyclooctane (DABCO), N,N,N′,N′-tetramethylbutanediamine (TMBD) and dimethyltin dilaurate (DMTD); antioxidants for example Irganox (Registered Trade Mark); radical inhibitors for example trisnonylphenyl phosphite (TNPP); stabilisers; lubricants for example Irgawax (Registered Trade Mark); dyes; pigments; inorganic and/or organic fillers; and reinforcing materials can be incorporated into the polyurethane during preparation. Such additives are preferably added to the macrodiol mixture in step (i) of the processes of the present invention.

The polyurethanes of the present invention are particularly useful in preparing biomaterials and medical devices, articles or implants as a consequence of their biostability and creep resistance.

The term “biostable” is used herein in its broadest sense and refers to a stability when in contact with cells and/or bodily fluids of living animals or humans.

The term “biomaterial” is used herein in its broadest sense and refers to a material which is used in situations where it comes into contact with the cells and/or bodily fluids of living animals or humans.

The medical devices, articles or implants may include catheters; stylets; bone suture anchors; vascular, oesophageal and bilial stents; cochlear implants; reconstructive facial surgery; controlled drug release devices; components in key hole surgery; biosensors; membranes for cell encapsulations; medical guidewires; medical guidepins; cannularizations; pacemakers, defibrillators and neurostimulators and their respective electrode leads; ventricular assist devices; orthopaedic joints or parts thereof including spinal discs and small joints; cranioplasty plates; intraoccular lenses; urological stents and other urological devices; stent/graft devices; device joining/extending/repair sleeves; heart valves; vein grafts; vascular access ports; vascular shunts; blood purification devices; casts for broken limbs; vein valve, angioplasty, electrophysiology and cardiac output catheters; and tools and accessories for insertion of medical devices, infusion and flow control devices.

It will be appreciated that polyurethanes having properties optimised for use in the construction of various medical devices, articles or implants and possessing creep resistance will also have other non-medical applications. Such applications may include toys and toy components, shape memory films, pipe couplings, electrical connectors, zero-insertion force connectors, Robotics, Aerospace actuators, dynamic displays, flow control devices, sporting goods and components thereof, body-conforming devices, temperature control devices, safety release devices and heat shrink insulation.

### EXAMPLES

The invention will now be described with reference to the following non-limiting examples.

### Example 1

A series of four polyurethanes were prepared to illustrate the effect of incorporating the tri-functional cross linker trimethylol propane (TMP) on creep resistance and mechanical properties.

Raw Materials: Poly(hexamethylene oxide) (PHMO) was synthesised and purified according to previously reported method (Gunatillake P A, Meijs G F, Chatelier R C, McIntosh and Rizzardo E., Polymer Int. 27, 275 (1992). PHMO was degassed at 135° C. under vacuum (0.01 torr) for 2 h. α,ω-bis(6-hydroxy-ethoxypropyl)-polydimethylsiloxane (PDMS) was purchased from Shin-Etsu (Japan) and degassed at 105° C. under vacuum (0.01 torr) for 4 h. 1,3-Bis(4-hydroxybutyl) 1,1,3,3-tertamethyldisiloxane (BHTD, Silar Laboratories) was degassed at ambient temperature under vacuum (0.01 torr) for several hours (˜12 h). 1,4-butanediol (BDO, Aldrich) was degassed and dried at 105° C. for 2 h prior to use.

The moisture content of all reagents was determined using Columetric Karl-Fisher titration. The moisture level of all reagents remained below 150 ppm.

The hydroxy number of the polyols (PDMS and PHMO) and of BHTD was determined using ASTM 2628 method.

The following procedure illustrates the preparation of the prepolymer used to make all four polyurethanes.

A mixture of PDMS (200.00 g, MW 927.0) and PHMO (50.00 g, MW 710.0) was degassed at 105° C. for 2 h under vacuum (0.01 torr). Molten MDI (102.71 g) was weighed into a three-neck round bottom flask equipped with mechanical stirrer, dropping funnel and nitrogen inlet. The flask was heated in an oil bath at 70° C. The degassed macrodiol mixture (200.0 g) was then added through a dropping funnel over a period of 45 minutes. After the addition is over, the reaction mixture was heated for 2 h with stirring under nitrogen at 80° C. The prepolymer mixture was then degassed at 80° C. under vacuum (0.01 torr) for about 1 h. The vacuum was released slowly under nitrogen atmosphere and 280.0 g of the degassed pre-polymer mixture was weighed into a tall dry polypropylene beaker and immediately placed in a nitrogen circulating oven at 80° C.

The un cross linked thermoplastic polyurethane PU-0 was prepared by reacting prepolymer (280.00 g) and a mixture of BDO (9.0769 g) and BHTD (19.2479 g). The chain extender mixture was weighed into a wet-tared 50 mL plastic syringe and added to the prepolymer with high speed stirring (4500 rpm) using a Silverson Mixer. The stirring continued for 2 min after addition of chain extender mixture. The polymer mixture was then poured into several Teflon-cloth lined aluminium moulds to produce 3 mm and 10 mm thick sheets. The polymer in moulds was first cured under 4 ton nominal pressure in a compression moulding press at 100° C. for 2 hours followed by further curing for 15 h in a nitrogen circulating oven at 100° C.

The cross linked polyurethanes were prepared by incorporating various amounts of TMP as indicated in Table 1. Three different concentrations of TMP replacing 10, 20 and 40 mol-% of BDO used in the formulation of un cross linked polyurethane (PU-0) were used. This corresponds to cross link density of 1.4, 2.8 and 5.5%, respectively for PU-10, PU-20 and PU-40, expressed as mol-% cross linker relative to the total number of moles of reagents used. The following procedure which illustrates the preparation PU-20 describes the general procedure used in making all cross linked polyurethanes.

BDO (7.2611 g) and TMP cross linker (1.792) were mixed in a round bottom flask and stirred for about 2 min at 40° C. temperature to obtain a homogenous solution. 19.2479 g BHTD weighed separately was then added to this flask and stirred for about 30 minutes to obtain a homogenous solution. The chain extender mixture and cross linker (28.301 g) were then weighed into a wet-tarred syringe and added into the pre-polymer mixture (280.0 g) while high speed (4500 rpm) stirring using Silverson Mixer. Stirring was continued for about 2 min after addition. The polymer mixture was poured into Teflon-cloth lined aluminium moulds to produce 3 mm and 10 mm sheets. The polymer in moulds was first cured under 4 ton nominal pressure in a compression moulding press at 100° C. for 2 hours followed by further curing for 15 h in a nitrogen circulating oven at 100° C.

TABLE 1
Quantities of reagents used in making the polyurethanes of Example 1

| Sample | Prepolymer | BDO | | |
|---|---|---|---|---|
| code | (g) | (g) | BHTD (g) | TMP (g) |
| PU-0 | 280.0 | 9.0769 | 19.2479 | — |
| PU-10 | 280.0 | 8.1697 | 19.2479 | 0.896 |
| PU-20 | 280.0 | 7.2611 | 19.2479 | 1.792 |
| PU-40 | 280.0 | 5.4467 | 19.2479 | 3.584 |

Mechanical Properties and Procedures for Testing Mechanical Properties and Tensile Creep for the Polyurethanes of Example 1

The material was conditioned at ambient conditions for 48 h before testing.

Specimen Type

ISO Dumbbell
Gauge length: 20 mm
Width: 40 mm
Thickness:˜3 mm
   Equipment
Instron 5866 with 5800 Console
Merlin Software
Load Cell:1000N
Long Range, Contact Extensometer
   Method for Tensile Modulus
Number of Specimens: 2
Speed: 1 mm/min
The specimen is strained to 1.3%
Modulus is determined over the range 0.05% strain-0.95% strain. Nine points are taken in the range and a line of best fit is determined by the software, the slope of the line is the material's Young's modulus.
   Method for Tensile Strength and Tensile Strain at Break
Number of Specimen: 2
Speed: 200 mm/min
Load is applied until failure, ultimate tensile strength and the % tensile strain at break are recorded
   Method for Tensile Creep
Number of Specimen: 1
The gauge length is measured using a microscope with magnification times 10, the microscope (Vision Engineering, with Acu-Rite) is connected to digital measuring device (Quadracheck 200). Points are selected manually and the instrument calculates the distance between those points, giving the gauge length
Load of 60N applied within 10 seconds
Specimen held at a load of 60N for 120 mins, the % strain is recorded at 0, 2, 4, 6, 8, 10, 15, 20, 25, 30, 40, 50, 60, 70, 80, 90, 100, 110, 120 mins
After 120 mins the specimen is released from the grips
The gauge length is measured at 120, 122, 124, 126, 128, 130, 135, 140, 145, 150, 160, 170, 180, 190, 200, 210 and 220 minutes, using the microscope.
The strain is calculated using the original gauge length.
The Strain versus time is plotted in an excel spreadsheet.

The introduction of cross linking caused a reduction in tensile strength, elongation at break and modulus, however, the materials retained strengths over 20 MPa. It is surprising that such low modulus materials with high strength can be achieved with a relatively low level of cross linking.

TABLE 2
Mechanical Properties of Polyurethanes of Example 1

| | Cross Link | Modulus of | Tensile | | Durometer |
|---|---|---|---|---|---|
| Sample | Density | Elasticity* | strength | % Strain at | Hardness |
| Code | (mol-%) | (MPa) | (MPa) | break | Shore A |
| PU-0 | 0 | 10.03 | 29.51 | 532 | 79 |
| PU-10 | 1.4 | 8.62 | 23.36 | 525 | 81 |
| PU-20 | 2.8 | 6.36 | 23.14 | 446 | 80 |
| PU-40 | 5.5 | 4.82 | 20.33 | 370 | 74 |

Resistance to Tensile Creep

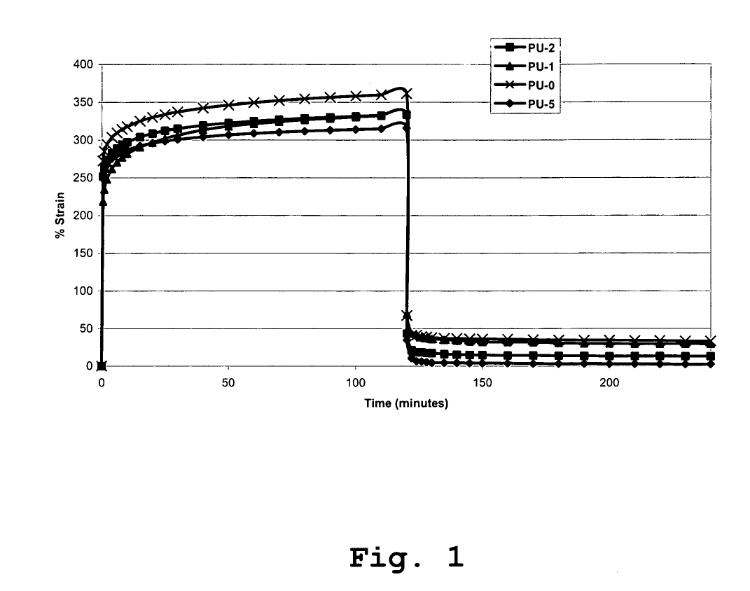

The resistance to tensile creep was measured on dumbbell shaped test specimens using an Instron Tester The test specimen was loaded to 60N (in about 10 sec), translating to a stress of approximately 5 MPa, and held for 2 hours. After 2 hours the specimen was taken off the Instron and the gauge length was measured intermittently for 2 hours. The results are summarised in FIG. 1.

The results clearly demonstrate that the cross linked polyurethanes were significantly more resistant to creep compared to un cross linked polyurethane. Increasing cross link density increased the creep resistance and the material with the highest cross link density showed complete recovery after removing the load.

Effect of Cross Linking on Polymer Solubility

The polymers prepared in Example 1 were tested for their solubility/swelling in N,N-dimethylformamide (DMF), a good solvent for polyurethanes. A rectangular specimen of polymer (approximately 1 g) was placed in excess DMF (˜30 mL) at 50° C. for 48 h. The excess DMF was wiped off from the polymer surface by using Kimwipe and weighed again to calculate the swelling ratio, expressed as the % weight gain relative to the dry sample. The results shown in Table 3 illustrate that the cross linked polymers swelled in DMF indicating the synthesis was successful and the presence of covalent cross linking.

TABLE 3
Effect of N,N-dimethylformamide on polymers in Example 1

| Sample Code | Swelling Ratio |
|---|---|
| PU-0 | Dissolved^{a} |
| PU-10 | 6.4 |
| PU-20 | 3.91 |
| PU-40 | 2.07 |

^{a}The GPC analysis of PU-0 showed a number average molecular weight of 106,00 and polydispersity of 2.7.

### Example 2

This example illustrates the preparation of a polyurethane using the tetra-functional cross linker pentaerythritol (PE). The amount of PE used corresponds to 20 mol % of the BDO chain extender resulting in an effective cross link density of 2.653, expressed as mol-% of all components.

A mixture of PDMS (200.00 g, MW 927.0) and PHMO (50.00 g, MW 710.0) was degassed at 105° C. for 2 h under vacuum (0.01 torr). Molten MDI (102.71 g) was weighed into a three-neck round bottom flask equipped with mechanical stirrer, dropping funnel and nitrogen inlet. The flask was heated in an oil bath at 70° C. The degassed macrodiol mixture (200.0 g) was then added through a dropping funnel over a period of 45 minutes. After the addition is over, the reaction mixture was heated for 2 h with stirring under nitrogen at 80° C. The prepolymer mixture was then degassed at 80° C. under vacuum (0.01 torr) for about 1 h. The vacuum was released slowly under nitrogen atmosphere and 280.0 g of the degassed pre-polymer mixture was weighed into a tall dry polypropylene beaker and immediately placed in a nitrogen circulating oven at 80° C.

BDO (7.2611 g) and pentaerythritol cross linker (PE, 1.3706 cg) was mixed in a round bottom flask and stirred for about 2 min at 40° C. temperature to obtain a homogenous solution. The mixture (8.6317 g) was weighed into a plastic syringe. 1,3-Bis(4-hydroxybutyl)1,1,3,3-tetramethyldsiloxane (BHTD, 19.2479 g) was weighed separately into a plastic syringe. BDO/PE and BHTD were added into the pre-polymer mixture (280.0 g) while stirring at high speed (4500 rpm) using Silverson Mixer and stirring continued for about 2 minutes. The polymer mixture was then poured into several Teflon-cloth lined aluminium moulds to produce 3 mm, and 10 mm thick sheets. The polymer in moulds was first cured under 4 ton nominal pressure in a compression moulding press at 100° C. for 2 hours followed by further curing for 15 h in a nitrogen circulating oven at 100° C.

### Example 3

This example illustrates the preparation of a polyurethane using the hexa-functional cross linker dipentaerythritol (DPE). The amount of DPE used corresponds to 20 mol % of the BDO chain extender.

A mixture of PDMS (200.00 g, MW 927.0) and PHMO (50.00 g, MW 710.0) was degassed at 105° C. for 2 h under vacuum (0.01 torr). Molten MDI (102.71 g) was weighed into a three-neck round bottom flask equipped with mechanical stirrer, dropping funnel and nitrogen inlet. The flask was heated in an oil bath at 70° C. The degassed macrodiol mixture (200.0 g) was then added through a dropping funnel over a period of 45 minutes. After the addition was over, the reaction mixture was heated for 2 h with stirring under nitrogen at 80° C. The prepolymer mixture was then degassed at 80° C. under vacuum (0.01 torr) for about 1 h. The vacuum was released slowly under nitrogen atmosphere and 280.0 g of the degassed prepolymer mixture was weighed into a tall dry polypropylene beaker and immediately placed in a nitrogen circulating oven at 80° C.

BDO (7.2611 g) and DPE cross linker (1.7073 g) were mixed in a round bottom flask separately whereas 1,3-Bis(4-hydroxybutyl)1,1,3,3-tetramethyldsiloxane (BHTD, 19.2479 g) was weighed separately into a plastic syringe. The BDO/DPE mixture was heated until it was a clear solution and added into the prepolymer mixture along with BHTD (19.24 g) while stirring at high speed (5000 rpm) using Silverson Mixer and stirring continued for about 2 minutes. The polymer mixture was then poured into several Teflon-cloth lined aluminium moulds to produce 3 mm, and 10 mm thick sheets. The polymer in moulds was first cured under 4 ton nominal pressure in a compression moulding press at 100° C. for 2 hours followed by further curing for 15 h in a nitrogen circulating oven at 100 C.°.

### Example 4

This example illustrates the preparation of a polyurethane using the octa-functional cross linker tripentaerythritol (TPE). The amount of TPE used corresponds to 20 mol % of the BDO chain extender.

A mixture of PDMS (200.00 g, MW 927.0) and PHMO (50.00 g, MW 710.0) was degassed at 105° C. for 2 h under vacuum (0.01 torr). Molten MDI (102.71 g) was weighed into a three-neck round bottom flask equipped with mechanical stirrer, dropping funnel and nitrogen inlet. The flask was heated in an oil bath at 70° C. The degassed macrodiol mixture (200.0 g) was then added through a dropping funnel over a period of 45 minutes. After the addition was over, the reaction mixture was heated for 2 h with stirring under nitrogen at 80° C. The prepolymer mixture was then degassed at 80° C. under vacuum (0.01 torr) for about 1 h. The vacuum was released slowly under nitrogen atmosphere and 280.0 g of the degassed prepolymer mixture was weighed into a tall dry polypropylene beaker and immediately placed in a nitrogen circulating oven at 80° C.

BDO (7.2611 g) and TPE cross linker (TPE, 1.88 g) were mixed in a round bottom flask separately whereas 1,3-Bis(4-hydroxybutyl)1,1,3,3-tetramethyldsiloxane (BHTD, 19.2479 g) was weighed separately into a plastic syringe. The BDO/TPE mixture was heated until it was a clear solution and added into the prepolymer mixture along with BHTD (19.24 g) while stirring at high speed (5000 rpm) using Silverson Mixer and stirring continued for about 2 minutes. The polymer mixture was then poured into several Teflon-cloth lined aluminium moulds to produce 3 mm, and 10 mm thick sheets. The polymer in moulds was first cured under 4 ton nominal pressure in a compression moulding press at 100° C. for 2 hours followed by further curing for 15 h in a nitrogen circulating oven at 100 C.°.

### Example 5

This example illustrates the addition of the tri-functional cross linker TMP of Example 1 to a polyurethane which does not include the silicon-containing chain extender BHTD.

A mixture of PDMS (200.00 g, MW 927.0) and PHMO (50.00 g, MW 710.0) was degassed at 105° C. for 2 h under vacuum (0.01 torr). Molten MDI (102.71 g) was weighed into a three-neck round bottom flask equipped with mechanical stirrer, dropping funnel and nitrogen inlet. The flask was heated in an oil bath at 70° C. The degassed macrodiol mixture (200.0 g) was then added through a dropping funnel over a period of 45 minutes. After the addition was over, the reaction mixture was heated for 2 h with stirring under nitrogen at 80° C. The prepolymer mixture was then degassed at 80° C. under vacuum (0.01 torr) for about 1 h. The vacuum was released slowly under nitrogen atmosphere and 280.0 g of the degassed prepolymer mixture was weighed into a tall dry polypropylene beaker and immediately placed in a nitrogen circulating oven at 80° C.

BDO (8.079 g) and TMP cross linker (4.287 g) were mixed in a round bottom flask and heated to 40° C. to obtain a clear solution. The BDO/TMP mixture was then added into the prepolymer mixture while stirring at high speed (5000 rpm) using Silverson Mixer and stirring continued for about 2 minutes. The polymer mixture was then poured into several Teflon-cloth lined aluminium moulds to produce 3 mm, and 10 mm thick sheets. The polymer in moulds was first cured under 4 ton nominal pressure in a compression moulding press at 100° C. for 2 hours followed by further curing for 15 h in a nitrogen circulating oven at 100 C.°.

### Example 6

This example illustrates the addition of the tri-functional cross linker TMP of Example 1 to the polyurethane of Examples 1 to 4 in which the amount of BHTD is reduced with constant BDO.

A mixture of PDMS (200.00 g, MW 927.0) and PHMO (50.00 g, MW 710.0) was degassed at 105° C. for 2 h under vacuum (0.01 torr). Molten MDI (102.71 g) was weighed into a three-neck round bottom flask equipped with mechanical stirrer, dropping funnel and nitrogen inlet. The flask was heated in an oil bath at 70° C. The degassed macrodiol mixture (200.0 g) was then added through a dropping funnel over a period of 45 minutes. After the addition was over, the reaction mixture was heated for 2 h with stirring under nitrogen at 80° C. The prepolymer mixture was then degassed at 80° C. under vacuum (0.01 torr) for about 1 h. The vacuum was released slowly under nitrogen atmosphere and 280.0 g of the degassed prepolymer mixture was weighed into a tall dry polypropylene beaker and immediately placed in a nitrogen circulating oven at 80° C.

BDO (9.076 g) and TMP cross linker (3.603 g) were mixed in a round bottom flask separately whereas BHTD (7.7093 g) was weighed separately into a plastic syringe. The BDO/TMP mixture was added into the prepolymer mixture along with BHTD (19.24 g) while stirring at high speed (5000 rpm) using Silverson Mixer and stirring continued for about 2 minutes. The polymer mixture was then poured into several Teflon-cloth lined aluminium moulds to produce 3 mm, and 10 mm thick sheets. The polymer in moulds was first cured under 4 ton nominal pressure in a compression moulding press at 100° C. for 2 hours followed by further curing for 15 h in a nitrogen circulating oven at 100 C.°.

### Example 7

This example illustrates the addition of a silicon-containing cross linking agent of formula (VI) to the polyurethane of Examples 1 to 4 in which the amount of cross linking agent of formula (VI) used corresponds to 20 mol % of the BDO chain extender.

A mixture of PDMS (200.00 g, MW 927.0) and PHMO (50.00 g, MW 710.0) was degassed at 105° C. for 2 h under vacuum (0.01 torr). Molten MDI (102.71 g) was weighed into a three-neck round bottom flask equipped with mechanical stirrer, dropping funnel and nitrogen inlet. The flask was heated in an oil bath at 70° C. The degassed macrodiol mixture (200.0 g) was then added through a dropping funnel over a period of 45 minutes. After the addition was over, the reaction mixture was heated for 2 h with stirring under nitrogen at 80° C. The prepolymer mixture was then degassed at 80° C. under vacuum (0.01 torr) for about 1 h. The vacuum was released slowly under nitrogen atmosphere and 280.0 g of the degassed prepolymer mixture was weighed into a tall dry polypropylene beaker and immediately placed in a nitrogen circulating oven at 80° C.

BDO (7.2611 g) and 1,3(6,7-dihydroxy ethoxy propyl)tetramethyl disiloxane cross linker (SC) (4.762 g) was mixed in a round bottom flask separately whereas 1,3-bis(4-hydroxybutyl)1,1,3,3-tetramethyldisiloxane (BHTD, 19.2479 g) was weighed separately into a plastic syringe. The BDO/SC mixture was added into the prepolymer mixture along with BHTD (19.24 g) while stirring at high speed (5000 rpm) using Silverson Mixer and stirring continued for about 2 minutes. The polymer mixture was then poured into several Teflon-cloth lined aluminium moulds to produce 3 mm, and 10 mm thick sheets. The polymer in moulds was first cured under 4 ton nominal pressure in a compression moulding press at 100° C. for 2 hours followed by further curing for 15 h in a nitrogen circulating oven at 100° C.

Mechanical Properties and Procedures for Testing Mechanical Properties and Tensile Creep for the Polyurethanes of Examples 2 to 7

TABLE 4
Mechanical Properties of Polyurethanes of Examples 2
to 7

| | | | | Durometer |
|---|---|---|---|---|
| | Modulus of | Tensile | % Strain | Hardness |
| Example | Elasticity (MPa) | strength (MPa) | at break | Shore A |
| 2 | 6.34 | 23.35 | 405 | 78 |
| 3 | 5.96 | 19.29 | 363 | 72 |
| 4 | 7.87 | 19.43 | 420 | 76 |
| 5 | 22.84 | 26.18 | 321 | 93 |
| 6 | 8.53 | 22.07 | 359 | 80 |
| 7 | 7.21 | 22.01 | 496 | — |

Method for Testing Films
Conditioning

The material is kept in the room in which it is to be tested for at least 48 hours prior to testing. The temperature of the room averages 23° C.

Specimen Type

ISO Rectangle
Gauge length: 100 mm
Width: 10 mm
Thickness:˜0.2 mm
   Equipment
Instron 5866 with 5800 Console
Merlin Software
Load Cell:1000N
Long Range, Contact Extensometer
   Method for Tensile Modulus
Number of Specimens: 2
Speed: 1 mm/min
The specimen is strained to 0.4%
Modulus is determined over the range 0.05% strain-0.3% strain. Nine points are taken in the range and a line of best fit is determined by the software, the slope of the line is the material's Young's modulus.
   Method for Tensile Strength and Tensile Strain at Break
Number of Specimen: 2
Speed: 500 mm/min
Load is applied until failure, ultimate tensile strength and the % tensile strain at break are recorded
   Method for Tensile Creep
Number of Specimen:1
The gauge length is measured using a microscope with magnification times 10, the microscope (Vision Engineering, with Acu-Rite) is connected to digital measuring device (Quadracheck 200). Points are selected manually and the instrument calculates the distance between those points, giving the gauge length
Load of 12N applied within 10 seconds (Stress applied is the same as for dumbbells, 5 MPa)
Specimen held at a load of 12N for 120 mins, the % strain is recorded at 0, 2, 4, 6, 8, 10, 15, 20, 25, 30, 40, 50, 60, 70, 80, 90, 100, 110, 120 mins
After 120 mins the specimen is released from the grips
The gauge length is measured at 120, 122, 124, 126, 128, 130, 135, 140, 145, 150, 160, 170, 180, 190, 200, 210 and 220 minutes, using the microscope.
The strain is calculated using the original gauge length.
The Strain versus time is plotted in an excel spreadsheet.

These results show that the higher functional cross linkers such as DPE improve the creep resistance significantly.

### Example 8

This example illustrates the preparation of a polyurethane using the trifunctional macrodiol, Voranol 2070, a trifunctional polyether polyol based on proproxylated glycerine having a number average molecular weight of 700 as a cross linking agent. This polyurethane does not contain any cross linker in the hard segment.

The prepolymer containing PDMS, PHMO AND MOI was prepared as described in Example 1.

The cross linked polyurethanes were prepared by incorporating two different amounts of Voranol 2070. The amounts of Voranol 2070 corresponded to 20 and 40 mole % of BDO used in the formulation of the un crosslinked polyurethane (PU-0).

BDO, BHTD and Voranol 2070 were mixed together in a round bottom flask for 30 min to obtain a homogeneous solution. The mixture was then weighed into a wet tared syringe and added into the prepolymer mixture while high speed (4500 rpm) stirring using the Silverson mixer. Stirring was continued for about 2 min after the addition. The polymer was poured into Teflon coated moulds to produce 3 mm thick sheets. The polymer was first cured under 4 ton nominal pressure in a compression moulding press at 100° C. for 2 hours followed by further curing for 15 h in a nitrogen circulating oven at 100° C.

TABLE 5
Quantities of reagents used in making the
polyurethanes of Example 8

| Sample | Prepolymer | BDO | | Voranol |
|---|---|---|---|---|
| code | (g) | (g) | BHTD (g) | 2070 (g) |
| PU-20V | 280 | 7.47 | 19.298 | 9.703 |
| PU-40V | 280 | 5.609 | 19.298 | 19.393 |

Mechanical Properties for the Polyurethanes of Example 8

The mechanical properties were tested using the procedures described in Example 1.

TABLE 6
Mechanical properties of polyurethanes of Example 8

| | Modulus of | Tensile | | Durometer |
|---|---|---|---|---|
| Sample | Elasticity | Strength | % Strain | Hardness |
| code | (MPa) | (MPa) | at Break | Shore A |
| PU-20V | 10.12 | 25.96 | 479 | 78 |
| PU-40V | 5.03 | 22.10 | 428 | 73 |

### REFERENCES

1. Gunatillake P A, Meijs G F and Adhikari A, International Patent Application PCT/AU98/00546, U.S. Pat. No. 6,420,452 B1
2. Adhikari R., Gunatillake P A., Mejis G F., McCarthy S J. J Appl Polym Sci (2002), 83, 736-746.
3. Gunatillake P A, Meijs G F, Chatelier R C, McIntosh D M and Rizzardo E, Polym. Int., Vol. 27, pp 275-283 (1992).

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A cross linked polyurethane or polyurethane urea having an NCO/OH or NH₂ stoichiometry of 1-1.015 which comprises a soft segment which is formed from:
(a) at least one polyether macrodiol and/or at least one polycarbonate macrodiol; and
(b) at least one polysiloxane macrodiol, at least one polysiloxane macrodiamine and/or at least one silicon-based polycarbonate; and/or a hard segment which is formed from:
(c) a polyisocyanate; and
(d) at least one di-functional chain extender, wherein the soft segment and/or the hard segment are further formed from:
(e) at least one cross linking agent.

2. A polyurethane or polyurethane urea according to claim 1 in which the cross linking agent (e) has 3 or more functional groups.

3. A polyurethane or polyurethane urea according to claim 2 in which the functional group is capable of reacting with isocyanate.

4. A polyurethane or polyurethane urea according to claim 2 or 3 in which the functional group is selected from OH and NR′R″ in which R′ and R″ are the same or different and selected from H, CO₂H and C₁₋₆ alkyl.

5. A polyurethane or polyurethane urea according to claim 1 in which the cross linking agent (e) is a hydroxyl, amine or silicon-containing cross linking agent.

6. A polyurethane or polyurethane urea according to claim 5 in which the hydroxyl cross linking agent is selected from trimethylol propane (TMP), trifunctional polyether polyol based on polytetramethylene oxide (Voranol 2070), pentaerythritol (PE), pentaerythritol tetrakis(2-mercapto acetate), dipentaerythritol (DPE) and tripentaerythritol (TPE).

7. A polyurethane or polyurethane urea according to claim 5 in which the amine cross linking agent is triethanol amine.

8. A polyurethane or polyurethane urea according to claim 5 in which the silicon-containing cross linking agent is a cyclic siloxane of the formula (VII): 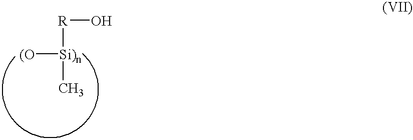
wherein
n is an integer of 3 or greater; and
R is an optionally substituted straight chain, branched or cyclic, saturated or unsaturated hydrocarbon radical having a backbone of at least 3 carbon atoms; or 1,3(6,7-dihydroxy ethoxypropyl)tetramethyl disiloxane of formula (VI):

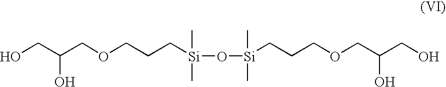

9. A polyurethane or polyurethane urea according to claim 8 in which the cyclic siloxane is tetramethyl tetrahydroxy propyl cyclotetrasiloxane of formula (V):

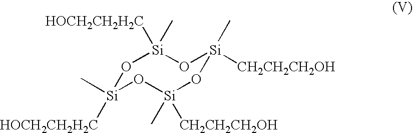

10. A polyurethane or polyurethane urea according to claim 1 in which the soft segment which is formed from components (a) and (b) is a combination of at least two macrodiols, at least two macrodiamines or at least one macrodiol and at least one macrodiamine.

11. A polyurethane or polyurethane urea according to claim 1 in which the polyether macrodiol is represented by the formula (I)
HO—[(CH₂)ₘ—O]ₙ—H (I)
wherein
m is an integer of 4 or more; and
n is an integer of 2 to 50.

12. A polyurethane or polyurethane urea according to claim 11 in which m is 5 or higher.

13. A polyurethane or polyurethane urea according to claim 12 in which the polyether macrodiol selected from polyhexamethylene oxide (PHMO), polyheptamethylene oxide, polyoctamethylene oxide (POMO) and polydecamethylene oxide (PDMO)

14. A polyurethane or polyurethane urea according to claim 11 in which the molecular weight range of the polyether macrodiol is about 200 to about 5000 or about 200 to about 1200.

15. A polyurethane or polyurethane urea according to claim 1 in which the polycarbonate macrodiol is selected from poly(alkylene carbonates), polycarbonates prepared by reacting alkylene carbonate with alkanediol and silicon based polycarbonates.

16. A polyurethane or polyurethane urea according to claim 15 in which the polyalkylene carbonate is selected from poly(hexamethylene carbonate) and poly(decamethylene carbonate).

17. A polyurethane or polyurethane urea according to claim 15 in which the polycarbonate prepared by reacting alkylene carbonate with alkanediol is selected from 1,4-butanediol, 1,10-decanediol (DD), 1,6-hexanediol (HD) and 2,2-diethyl 1,3-propanediol (DEPD).

18. A polyurethane or polyurethane urea according to claim 15 in which the silicon based carbonate is prepared by reacting alkylene carbonate with 1,3-bis(4-hydroxybutyl)-1,1,3,3-tetramethyldisiloxane (BHTD) and/or alkanediols.

19. A polyurethane or polyurethane urea according to claim 1 in which the polyether and polycarbonate macrodiols are in the form of a mixture or a copolymer.

20. A polyurethane or polyurethane urea to claim 19 in which the copolymer is a copoly(ether carbonate) macrodiol represented by the formula (II) 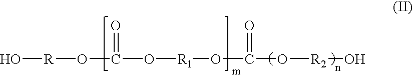
wherein
R₁ and R₂ are the same or different and selected from an optionally substituted straight chain, branched or cyclic alkylene, alkenylene, alkynylene or heterocyclic radical; and
m and n are integers of 1 to 20.

21. A polyurethane or polyurethane urea according to claim 1 in which polysiloxane macrodiol or macrodiamine is represented by the formula (III): 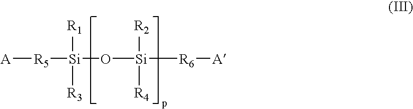
wherein
A and A′ are OH or NHR wherein R is H or an optionally substituted straight chain, branched or cyclic, saturated or unsaturated hydrocarbon radical;
R₁, R₂, R₃ and R₄ are the same or different and selected from hydrogen or an optionally substituted straight chain, branched or cyclic, saturated or unsaturated hydrocarbon radical;
R₅ and R₆ are the same or different and selected from an optionally substituted straight chain, branched or cyclic alkylene, alkenylene, alkynylene or heterocyclic radical; and
p is an integer of 1 or greater.

22. A polyurethane or polyurethane urea according to claim 21 in which the polysiloxane is a polysiloxane macrodiol of the formula (III) wherein A and A′ are hydroxy and is represented by the formula (IIIa): 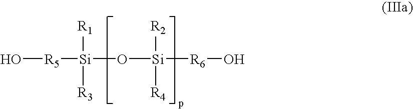
wherein
R₁ to R₆ and p are as defined in claim 21.

23. A polyurethane or polyurethane urea according to claim 22 in which the polysiloxane is polydimethyl siloxane (PDMS) which is a compound of formula (IIIa) wherein R₁ to R₄ are methyl.

24. A polyurethane or polyurethane urea according to claim 23 in which R₅ and R₆ are the same or different and selected from propylene, butylene, pentylene, hexylene, ethoxypropyl (—CH₂CH₂OCH₂CH₂CH₂—), propoxypropyl and butoxypropyl.

25. A polyurethane or polyurethane urea according to claim 21 in which the molecular weight range of the polysiloxane macrodiol is about 200 to about 6000 or about 500 to about 2500.

26. A polyurethane or polyurethane urea according to claim 21 in which the polysiloxane is a polysiloxane macrodiamine which has the formula (III) as defined in claim 21 wherein A is NH₂.

27. A polyurethane or polyurethane urea according to claim 25 in which the polysiloxane macrodiamine is amino-terminated PDMS.

28. A polyurethane or polyurethane urea according to claim 1 in which the silicon-based polycarbonate has the formula (IV): 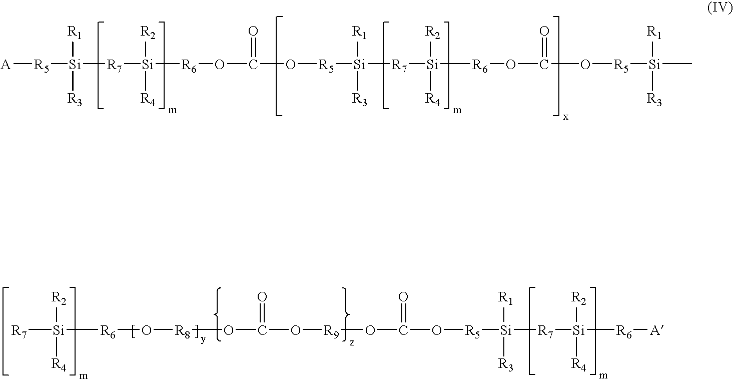
wherein
R₁, R₂, R₃, R₄ and R₅ are as defined in formula (III) above;
R₆ is an optionally substituted straight chain, branched or cyclic alkylene, alkenylene, alkynylene or heterocyclic radical;
R₇ is a divalent linking group;
R₈ and R₉ are same or different and selected from hydrogen or an optionally substituted straight chain, branched or cyclic, saturated or unsaturated hydrocarbon radical;
A and A′ are as defined in formula (III) above;
m, y and z are integers of 0 or more; and
x is an integer of 0 or more.

29. A polyurethane or polyurethane urea according to claim 28 in which polycarbonate is a compound of the formula (IV) wherein A and A′ are hydroxy which is a polycarbonate macrodiol of the formula (IVa): 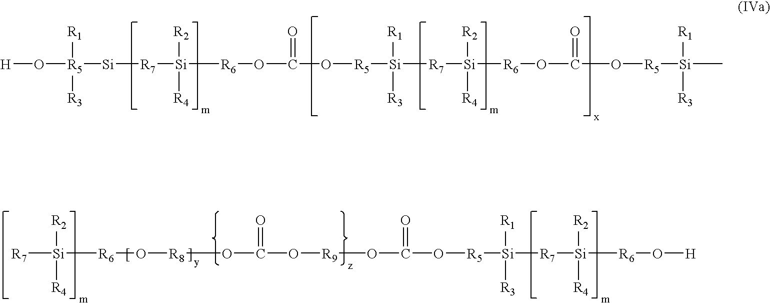
wherein
R₁ to R₉, m, y, x and z are as defined in claim 30.

30. A polyurethane or polyurethane urea according to claim 28 in which the molecular weight range of the polycarbonate macrodiol is about 400 to about 5000 or about 400 to about 2000.

31. A polyurethane or polyurethane urea according to claim 1 in which the soft segment is a combination of PDMS or amino-terminated PDMS with a polyether of the formula (I) and/or a silicon-based polycarbonate.

32. A polyurethane or polyurethane urea according to claim 1 in which the polyisocyanate (c) is a di or higher isocyanate selected from polymeric 4,4′-diphenylmethane diisocyanate (MDI),. MDI, methylene biscyclohexyl diisocyanate (H₁₂MDI), p-phenylene diisocyanate (p-PDI), trans-cyclohexane-1,4-diisocyanate (CHDI), 1,6-diisocyanatohexane (DICH), 1,5-diisocyanatonaphthalene (NDI), para-tetramethylxylenediisocyanate (p-TMXDI), meta-tetramethylxylene diisocyanate (m-TMXDI), 2,4-toluene diisocyanate (2,4-TDI) isomers or mixtures thereof or isophorone diisocyanate (IPDI).

33. A polyurethane or polyurethane urea according to claim 32 in which the polyisocyanate is MDI.

34. A polyurethane or polyurethane urea according to claim 1 in which the di-functional chain extender (d) is a compound having two functional groups per molecule which are capable of reacting with an isocyanate group.

35. A polyurethane or polyurethane urea according to claim 34 in which the di-functional chain extender (d) has a molecular weight range of about 500 or less, about 15 to about 500 or about 60 to about 450.

36. A polyurethane or polyurethane urea according to claim 1 in which the di-functional chain extender is selected from diol, diamine and silicone-containing chain extenders.

37. A polyurethane or polyurethane urea according to claim 36 in which the diol chain extender is selected from 1,4-butanediol, 1,6-hexanediol, 1,8-octanediol, 1,9-nonanediol, 1,10-decanediol, 1,12-dodecanediol,1,4-cyclohexanediol, 1,4-cyclohexanedimethanol, p-xyleneglycol, 1,3-bis(4-hydroxybutyl)tetramethyldisiloxane, 1,3-bis(6-hydroxyethoxypropyl)tetramethyldisiloxane and 1,4-bis(2-hydroxyethoxy)benzene.

38. A polyurethane or polyurethane urea according to claim 36 in which the diamine chain extender is selected from 1,2-ethylenediamine, 1,3-propanediamine,1,4-butanediamine, 1,3-bis(3-aminopropyl)tetramethyldisiloxane, 1,3-bis(4-aminobutyl)tetramethyldisiloxane and 1,6-hexanediamine.

39. A polyurethane or polyurethane urea according to claim 36 in which the silicon-containing chain extender is a silicon-containing diol of the formula (VI): 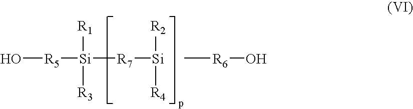
wherein
R₁, R₂, R₃, R₄, R₅ and R₆ are as defined in formula (III) in claim 22;
R₇ is as defined in formula (IV) in claim 26; and
q is 0 or greater.

40. A polyurethane or polyurethane urea according to claim 39 in which the silicon-containing diol of the formula (VI) is selected from 1,3-bis(4-hydroxybutyl)tetramethyl disiloxane (BHTD) (compound of formula (VI) wherein R₁, R₂, R₃ and R₄ are methyl, R₅ and R₆ are butyl and R₇ is O), 1,4-bis(3-hydroxypropyl)tetramethyl disilylethylene (compound of formula (VI) wherein R₁, R₂, R₃ and R₄ are methyl, R₅ and R₆ are propyl and R₇ is ethylene) and 1-4-bis(3-hydroxypropyl)tetramethyl disiloxane.

41. A polyurethane or polyurethane urea according to claim 39 in which the di-functional chain extender is a combination of a silicon-containing chain extender of formula (VI) and a diol or diamine chain extender.

42. A polyurethane or polyurethane urea according to claim 41 in which the di-functional chain extender of formula (VI) is BHTD and the diol chain extender is BDO.

43. A polyurethane or polyurethane urea according to claim 41 in which the molar percentage of silicon chain extender relative to the diol or diamine chain extender is about 1 to about 70%.

44. A polyurethane or polyurethane urea according to claim 1 in which the amount of hard segment is about 15 to about 100 wt %, about 20 to about 70% wt or about 30 to about 60 wt %.

45. A polyurethane or polyurethane urea according to claim 1 in which the molecular weight range of the soft segment is about 300 to about 3000, about 300 to about 2500 or about 500 to about 2000.

46. A polyurethane or polyurethane urea according to claim 1 in which the soft segment comprises macrodiols derived from 40 to 98 wt % of polysiloxane and 2 to 60 wt % of a polyether and/or polycarbonate macrodiol.

47. A polyurethane or polyurethane urea according to claim 1 in which the weight ratio of polysiloxane and/or silicon-based polycarbonate to polyether and/or polycarbonate in the soft segment is in the range of from 1:99 to 99:1.

48. A compound of formula (V) as defined in claim 9.

49. A process for preparing the polyurethane or polyurethane urea defined in claim 1 which comprises the steps of:
(i) reacting components (a), (b) and (c) as defined in claim 1 to form a prepolymer having terminally reactive polyisocyanate groups; and
(ii) reacting the prepolymer with components (d) and (e) defined in claim 1.

50. A process for preparing the polyurethane or polyurethane urea defined in claim 1 which comprises the steps of:
(i) mixing components (a), (b), (d) and (e) defined in claim 1; and
(ii) reacting the mixture with component (c) defined in claim 1.

51. A process according to claim 50 in which step (i) is carried out at temperatures in the range of about 45 to about 100° C.

52. A process according to claim 50 in which a catalyst is added in step (i).

53. A process according to claim 52 in which the catalyst is stanneous octoate or dibutyl tin dilaurate.

54. A process according to claim 49 or 50 in which polyurethane processing additives are added in step (i) selected from radical inhibitors, stabilisers, lubricants, dyes, pigments, inorganic fillers organic fillers and reinforcing materials.

55. A material, device, article or implant which is wholly or partly composed of the polyurethane or polyurethane urea defined in claim 1.

56. A material device, article or implant according to claim 55 selected from catheters; stylets; bone suture anchors; vascular, oesophageal and bilial stents; cochlear implants; reconstructive facial surgery; controlled drug release devices; components in key hole surgery; biosensors; membranes for cell encapsulations; medical guidewires; medical guidepins; cannularizations; pacemakers, defibrillators and neurostimulators and their respective electrode leads; ventricular assist devices; orthopaedic joints or parts thereof; spinal discs; small joints; cranioplasty plates; intraoccular lenses; urological stents and other urological devices; stent/graft devices; device joining/extending/repair sleeves; heart valves; vein grafts; vascular access ports; vascular shunts; blood purification devices; casts for broken limbs; vein valve, angioplasty, electrophysiology and cardiac output catheters; tools and accessories for insertion of medical devices, infusion and flow control devices; toys and toy components; shape memory films; pipe couplings; electrical connectors; zero-insertion force connectors; Robotics; Aerospace actuators; dynamic displays; flow control devices; sporting goods and components thereof; body-conforming devices; temperature control devices; safety release devices; and heat shrink insulation.
